(19) United States
(12) Patent Application Publication
(10) Pub. No.: US 2025/0150398 A1
(43) Pub. Date: May 8, 2025

(54) METHOD AND DEVICE FOR CONTROLLING TRANSMISSION CONTROL PROTOCAL PERFORMANCE IN WIRELESS NETWORK AND SYSTEM THEREOF

(71) Applicant: DELTA ELECTRONICS, INC., Taoyuan City (TW)

(72) Inventors: Yu-Wei LEE, Taoyuan City (TW); Yi-An CHEN, Taoyuan City (TW); Hsiang-Ting FANG, Taoyuan City (TW)

(21) Appl. No.: 18/608,373

(22) Filed: Mar. 18, 2024

(30) Foreign Application Priority Data
Nov. 2, 2023 (CN) 202311450480.7

(51) Int. Cl. H04L 47/193; H04L 43/0829; H04L 47/34

(52) U.S. Cl. CPC H04L 47/193; H04L 43/0829; H04L 47/34

(57) ABSTRACT

A method for controlling transmission control protocol performance in a wireless network is provided. The method is used in a server device and the server device is in communication with a client device based on a TCP connection. The method includes receiving a plurality of packets from a TCP layer in the server device. The method includes storing the packets in a buffer, recording the packets in a transmission list, and forwarding the packets to the client device, wherein each packet has a packet sequence number. In response to receiving a packet acknowledgment message sent from the client device, the method includes determining a packet loss rate of the client device based on the packet acknowledgment message. The method includes dynamically adjusting a congestion window size of the TCP connection based on the packet loss rate to control a transmission rate of the TCP layer.

### CROSS REFERENCE TO RELATED APPLICATIONS

This application claims priority from China Patent Application No. 202311450480.7, filed on Nov. 2, 2023, the disclosure of which is incorporated herein in its entirety by reference.

### BACKGROUND OF THE APPLICATION

### Field of the Application

The present disclosure generally relates to wireless network communication technologies. More specifically, aspects of the present disclosure relate to a method and device for controlling Transmission Control Protocol (TCP) performance in a wireless network and system thereof.

### Description of the Related Art

In the environment of wireless communication networks (such as 5G, Wi-Fi, etc.), factors such as object obstruction, high-speed movement, and the device being too far from the base station will cause the signal-to-noise ratio (SNR) to be too low, causing packets to be discarded due to transmission errors.

The Transmission Control Protocol (TCP) was originally developed for wired networks. Since wired networks have very little packet loss on the links and the predominant source of loss is buffer overflow due to congestion, TCP's approach of inferring congestion from losses works well.

In contrast, wireless networks are characterized by packet loss on the link. When packets are lost, TCP may consider that the network is congested and slow down the network. When the packet loss rate is 5%, due to the overreaction of the slowdown mechanism, TCP's performance is only about 22% of its original speed.

Therefore, a new network architecture and mechanism are needed to improve and control the transmission performance of TCP in a wireless communication environment.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method and device for controlling Transmission Control Protocol (TCP) performance in a wireless network and system thereof, which can actively retransmit lost packets and dynamically control the TCP congestion window size (Cwnd) to increase the transmission rate of the TCP connection.

In an exemplary embodiment, a method for controlling transmission control protocol performance in a wireless network is provided. The method is used in a server device and the server device is in communication with a client device based on a TCP connection. The method includes receiving a plurality of packets from a TCP layer in the server device. The method includes storing the packets in a buffer, recording the packets in a transmission list, and forwarding the packets to the client device, wherein each packet has a packet sequence number. The method includes in response to receiving a packet acknowledgment message sent from the client device, determining a packet loss rate of the client device based on the packet acknowledgment message. The method includes dynamically adjusting a congestion window size of the TCP connection based on the packet loss rate to control a transmission rate of the TCP layer.

In some embodiments, the packet acknowledgment message comprises a latest confirmation sequence number and lost packet sequence numbers. The method further comprises retransmitting lost packets corresponding to the lost packet sequence numbers to the client device according to the packet acknowledgment message. The method further comprises deleting packets whose packet sequence numbers are smaller than the latest confirmation sequence number and are not the lost packet sequence numbers.

In some embodiments, the step of dynamically adjusting the congestion window size of the TCP connection based on the packet loss rate to control the transmission rate of the TCP layer further comprises obtaining an optimal congestion window threshold based on the packet loss rate, sending a first false acknowledgment message to the TCP layer to instruct the TCP layer to reduce the congestion window size when the congestion window size is greater than the optimal congestion window threshold, and sending a second false confirmation message to the TCP layer to instruct the TCP layer to increase the congestion window size when the congestion window size is smaller than the optimal congestion window threshold.

In some embodiments, the first false acknowledgment message is a duplicate acknowledgment (DUP ACK) message.

In some embodiments, the second false acknowledgment message is an acknowledgment (ACK) message.

In some embodiments, the method comprises receiving a first packet from the TCP layer. The method comprises checking whether a first packet sequence number of the first packet is in the transmission list. The method comprises when the first packet sequence number is not in the transmission list, storing the first packet in the buffer, recording the first packet in the transmission list, and forwarding the first packet to the client device. The method comprises discarding the first packet when the first packet sequence number is in the transmission list.

In some embodiments, the packet acknowledgment message comprises a selective acknowledgment (SACK) message.

In some embodiments, the packet acknowledgment message comprises an acknowledgment (ACK) message.

In an exemplary embodiment, a device for controlling transmission control protocol performance in a wireless network is provided. The device is in communication with a client device based on a TCP connection. The device comprises one or more processors and one or more computer storage media for storing one or more computer-readable instructions. The processor is configured to drive the computer storage media to execute the following tasks. The following tasks comprise using first training images to train a segmentation model. The following tasks comprise receiving a plurality of packets from a TCP layer in the device. The following tasks comprise storing the packets in a buffer, recording the packets in a transmission list, and forwarding the packets to the client device, wherein each packet has a packet sequence number. The following tasks comprise in response to receiving a packet acknowledgment message sent from the client device, determining a packet loss rate of the client device based on the packet acknowledgment message. The following tasks comprise dynamically adjusting a congestion window size of the TCP connection based on the packet loss rate to control a transmission rate of the TCP layer.

In an exemplary embodiment, a system for controlling transmission control protocol performance in a wireless network is provided. The system comprises a client device and a server device. The server device is in communication with based on a transmission control protocol (TCP) connection and executes the following tasks. The server device receives a plurality of packets from a TCP layer in the server device. The server device stores the packets in a buffer, records the packets in a transmission list, and forwards the packets to the client device, wherein each packet has a packet sequence number. In response to receiving a packet acknowledgment message sent from the client device, the server device determines a packet loss rate of the client device based on the packet acknowledgment message. The server device dynamically adjusts a congestion window size of the TCP connection based on the packet loss rate to control a transmission rate of the TCP layer.

### BRIEF DESCRIPTION OF DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram illustrating a system for controlling transmission control protocol performance in a wireless network according to an embodiment of the present disclosure.

FIG. 2 shows an internal architecture diagram of the server device according to an embodiment of the present disclosure.

FIG. 3 is a timing diagram for controlling transmission control protocol performance in a wireless network according to an embodiment of the present disclosure.

FIG. 4 is a schematic diagram showing a client device sending SACK information according to an embodiment of the present disclosure.

FIG. 5 is a schematic diagram illustrating a method for controlling transmission control protocol performance in a wireless network according to an embodiment of the present disclosure.

FIG. 6 illustrates an exemplary operating environment for implementing embodiments of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

The embodiments of the present disclosure provide a method and device for controlling Transmission Control Protocol (TCP) performance in a wireless network and system thereof, which can actively retransmit lost packets and dynamically control the TCP congestion window size (Cwnd) to increase the transmission rate of the TCP connection.

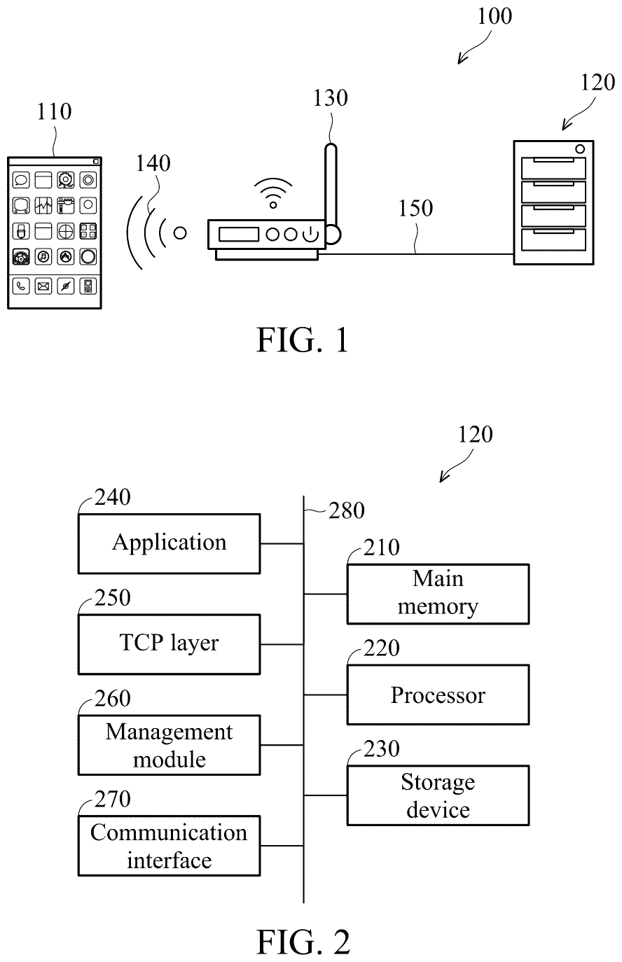

FIG. 1 is a schematic diagram illustrating a system 100 for controlling transmission control protocol performance in a wireless network according to an embodiment of the present disclosure. The system 100 comprises a client device 110, a server device 120 and a network node 130.

As shown in FIG. 1, the client device 110 transmits data with the server device 120 according to TCP via the network node 130. The client device 110 may be any type of mobile computing device equipped with mobile broadband circuitry, such as a notebook computer, a tablet computer, a handheld computing device, a web-enabled device, a gaming device, a mobile phone, a smartphone, an eBook reader, a personal digital assistant (PDA), or the like. The client device 110 may be any device suitable for communicating over a network (e.g., the wireless network 140) in accordance with, for example, one or more third Generation Partnership Project (3GPP) technical specifications.

According to embodiments, the client device 110 may be configured for intersystem communication across the wireless network 140. The wireless network 140 may comprise a wireless cellular network, such as a Global System for Mobile Communications (GSM) network, Universal Mobile Telecommunications System (UTMS), and/or a code division multiple access (CDMA) network. A wireless cellular network may adhere to one or more standards, such as Long Term Evolution (LTE) or LTE-Advanced (LTE-A), third Generation (3G), fourth Generation (4G), fifth Generation (5G), Worldwide Interoperability for Microwave Access (WiMAX) (e.g., mobile WiMAX), or other similar standard.

For communication over the wireless network 140, the client device 110 may operate on a cell. In some embodiments, the network node 130 may be adapted to provide this cell and, therefore, the network node 130 may be an access node, such as a Node B or an evolved Node B (eNB) (macro-eNB, pico-eNB, or femto-eNB), a Wi-Fi access point, a 5 Gg NodeB (gNB). In another embodiment, the network node 130 may be a gateway, such as a serving gateway (S-GW) or a packet data network gateway (P-GW). In embodiments in which the network node 130 is a gateway, the wireless network 140 and the network node 130 may be coupled with a plurality of components (not shown) associated with coupling the wireless network 140 to a core network in which the network node 130 is provided.

Through the network node 130, the client device 110 may be adapted to communicate with the server device 120 across the wireless network 140. Accordingly, the server device 120 may be any system adapted to provide a resource over the Internet 150. To communicate via the Internet 150, the client device 110 and the server device 120 may use TCP (e.g., TCP/IP).

FIG. 2 shows an internal architecture diagram of the server device 120 according to an embodiment of the present disclosure. The server device 120 may be any server that communicates with the client device 110 through the network node 130. The server device 120 may comprise, but is not limited to, a main memory 210, a processor 220, a storage device 230, and a communication interface 270. These components may be communicatively coupled through a bus 280. The bus 280 may be any subsystem suitable for transmitting data within the server device 120. The bus 280 may comprise a plurality of computer buses and other circuits suitable for transmitting data.

The processor 220 may be any processor suitable to execute instructions, such as instructions from the main memory 210. Accordingly, the processor 220 may be, for example, a central processing unit (CPU), a microprocessor, or another similar processor. In some embodiments, the processor 220 includes a plurality of processors, such as a dedicated processor (e.g., a graphics processing unit), a network processor, or any processor suitable to execute operations of the server device 120.

Coupled to the processor 220 is the main memory 210. The main memory 210 may offer both short-term and long-term storage and may in fact be divided into several units (including a unit located at the processor 220). The main memory 210 may also include cache memory, such as a cache located at the processor 220. The main memory 210 may be volatile, such as static random-access memory (SRAM) and/or dynamic random-access memory (DRAM), and may provide storage (at least temporarily) of computer-readable instructions, data structures, software applications, and other data for the server device 120. Such data may be loaded from the storage device 230, which may be, for example, one or more hard disk drives, solid state drives, compact disks and drives, and the like.

In another embodiment, the main memory 210 may comprise, but is not limited to, instructions related to an application 240 that is to be executed by the processor 220. The application 240 may be any application associated with communication of resources over the network. For example, the application 240 may be a browser application, a Voice over IP (VOIP) application, a cloud application, a media application, or the like.

In some embodiments, the application 240 may cause the communication interface 270 to communicate data to and from the client device 110 that is accessible over the Internet. Based on communication over the Internet, data sent to or from the application 240 may be processed at the TCP layer 250.

To reduce TCP traffic, a management module 260 may be implemented, for example, between the TCP layer 250 and the communication interface 270. The management module 260 may be hardware, software, firmware, and/or a combination of such. For example, the management module 260 may be included in an ASIC or other integrated circuit. In many embodiments, instructions associated with the management module 260 are to be executed by the processor 220 and, therefore, instructions associated with the management module 260 may be stored, at least temporarily, in main memory 210. In various embodiments, the management module 260 may be implemented at least partially in circuitry of the server device 120, such as processing circuitry, processor circuitry, logic circuitry, and the like. Thus, for example, management module circuitry may include circuitry configured to perform various operations described with respect to the management module 260.

In various embodiments, the management module 260 may be adapted to implement a private protocol between the server device 120 and the client device 110. The private protocol may allow the TCP layers of the server device and the user device to maintain TCP semantic while regulating TCP traffic between the server device 120 and the client device 110.

With respect to communication with the client device 110, the management module 260 may implement temporary storage or be communicatively coupled with a cache or a buffer, such as a cache or buffer at the main memory 210. The management module 260 may cache data packets from the TCP layer 250. This caching mechanism may allow the management module 260 to retransmit data packets received from the TCP layer 250 to the client device 110 when no TCP ACK is received from the client device 110 without requiring the TCP layer 250 to retransmit data packets that are not acknowledged as received by the client device 110.

The server device 120 may further comprise a communication interface 270. The communication interface 270 may allow the server device 120 to transmit data to the client device 110 through the network node 130.

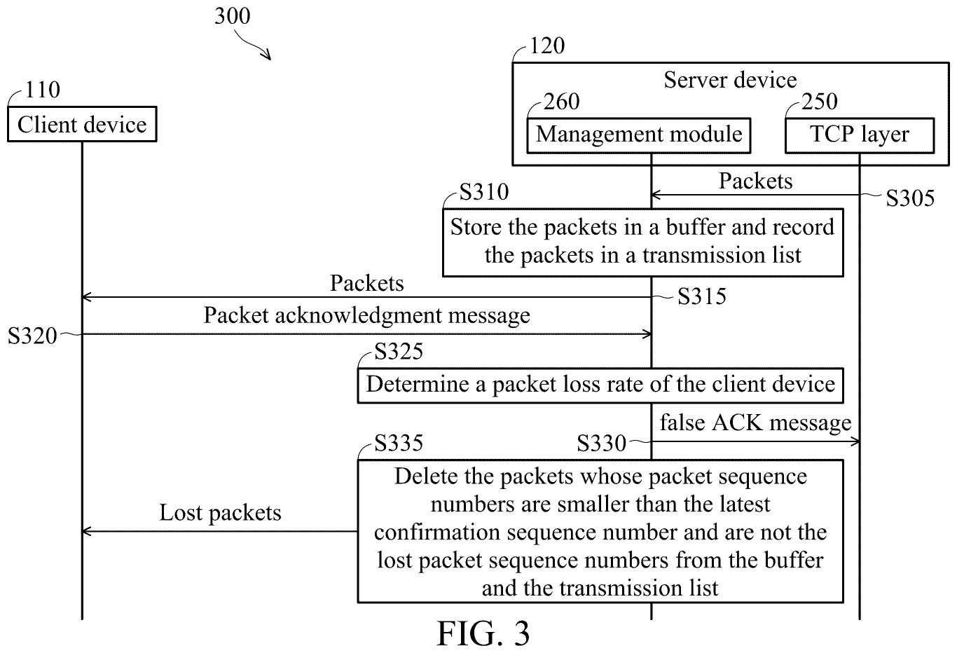

FIG. 3 is a timing diagram 300 for controlling transmission control protocol performance in a wireless network according to an embodiment of the present disclosure, with reference to FIGS. 1 and 2. FIG. 3 shows an example of the data communication sequence in the system 100 shown in FIG. 1, wherein the server device 120 is in communication with the client device 110 based on a Transmission Control Protocol (TCP) connection.

First, in step S305, the management module 260 of the server device 120 receives a plurality of packets from the TCP layer 250.

In step S310, the management module 260 may copy and store the packets in a buffer, and record the packets in a transmission list, wherein each packet has a packet sequence number.

In step S315, the management module 260 forwards the packet to the client device 110. It should be noted that the copied packets are still stored in the buffer.

In step S320, the management module 260 receives a packet acknowledgment message sent from the client device 110, wherein the packet acknowledgment message comprises the latest confirmation sequence number and a lost packet sequence number. In one embodiment, the packet acknowledgment message may comprise a selective acknowledgment (SACK) message or an acknowledgment (ACK) message.

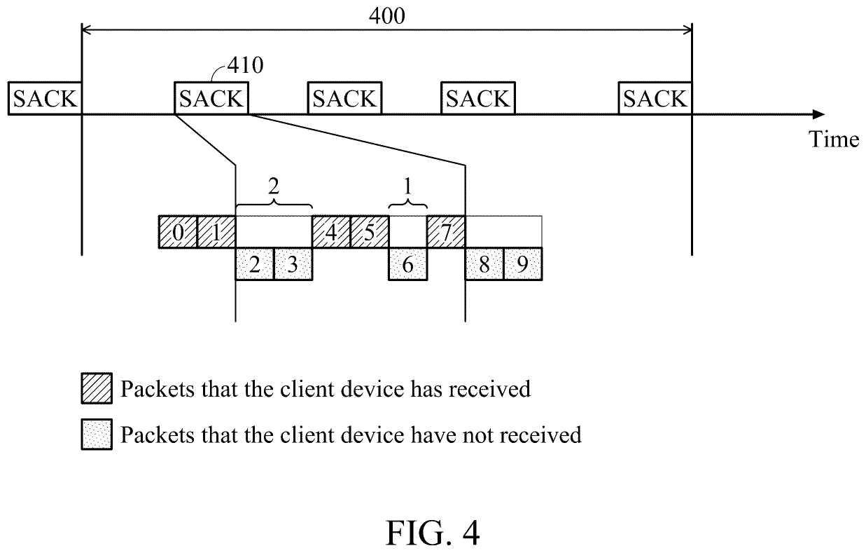

In step S325, the management module 260 determines the packet loss rate of the client device 110 based on the packet acknowledgment message. For example, when one or more packet are lost, the packet acknowledgment message sent by the client device 110 may include selective acknowledgment (SACK) information, wherein the SACK information may describe which packets have been received by the client device 110 and which packets have not been received by the client device 110. As shown in FIG. 4, the SACK information 410 sent by the client device 110 describes that the packets with sequence numbers 4, 5, and 7 have been received, but the packets with sequence numbers 2, 3, and 6 have not been received. The management module 260 may continue to receive packet acknowledgment messages including the SACK information, and count the number of packet losses within a time interval (for example, the time period 400) to calculate the packet loss rate of the client device 110 within this time interval.

In step S330, the management module 260 sends a false acknowledgment message to the TCP layer 250 according to the packet loss rate to adjust a congestion window size of the TCP connection.

Specifically, the management module 260 stores a lookup table, which comprises the corresponding relationship between the packet loss rate and the congestion window threshold, as shown in TABLE 1.

TABLE 1

| Packet loss rate | Congestion window threshold |
|---|---|
| 0% | 550 |
| 0.5% | 440 |
| 1% | 330 |
| 1.5% | 220 |
| 2% | 110 |
| >2.5% | 50 |

As an example, it is assumed that the congestion window size of the TCP connection is 350. When the management module 260 calculates and obtains the packet loss rate of the client device 110 as 1.5% based on the packet acknowledgment message, the management module 260 obtains the congestion window threshold corresponding to the packet loss rate of 1.5% based on TABLE 1 as 220. Since the congestion window size is greater than the congestion window threshold, the management module 260 sends a first false acknowledgment message to the TCP layer 250 to instruct the TCP layer 250 to reduce the congestion window size, wherein the first false acknowledgment message is a duplicate ACK (DUP ACK) message. When the management module 260 calculates and obtains the packet loss rate of the client device 110 as 0.5% based on the packet acknowledgment message, the management module 260 obtains the congestion window threshold corresponding to the packet loss rate of 0.5% based on TABLE 1 as 440. Since the congestion window size is smaller than the congestion window threshold, the management module 260 sends a second false acknowledgment message to the TCP layer 250 to instruct the TCP layer 250 to increase the congestion window size, wherein the second false acknowledgment message is an acknowledgment (ACK) message. In addition, it should be noted that although the corresponding relationship between the packet loss rate and the congestion window threshold is taken as an example in TABLE 1 in this embodiment, the disclosure should not be limited thereto and those skilled in the art can make appropriate replacements or adjustments according to this embodiment.

In step S335, the management module 260 can retransmit the lost packets corresponding to the lost packet sequence numbers to the client device 110 according to the packet acknowledgment message, and delete the packets whose packet sequence numbers are smaller than the latest confirmation sequence number and are not the lost packet sequence numbers from the buffer and the transmission list.

In one embodiment, since the management module 260 sends a false acknowledgment message to the TCP layer 250 for the purpose of dynamically adjusting the congestion window size of the TCP connection, the TCP layer 250 may resend the packets corresponding to the false acknowledgment message to the management module 260. The management module 260 may further check whether the packet sequence numbers of the packets retransmitted by the TCP layer 250 are in the transmission list. When the packet sequence numbers are not in the transmission list, the management module 260 copies and stores the packets in the buffer, records the packets in the transmission list, and forwards the packets to the client device 110 (i.e., the management device 260 repeats to execute steps S310 to S320). When the packet sequence numbers are in the transmission list (that is, the packets have been stored in the buffer), the management device 260 discards the packets.

In another embodiment, the management device 260 may also set a fixed period to check the transmission list, retransmit the lost packets to the client device 110 according to the lost packet sequence numbers in a recent packet acknowledgment message, and deletes packets whose packet sequence numbers are less than the latest confirmation sequence number in the latest packet acknowledgment message and are not lost packet sequence numbers from the buffer and the transmission list.

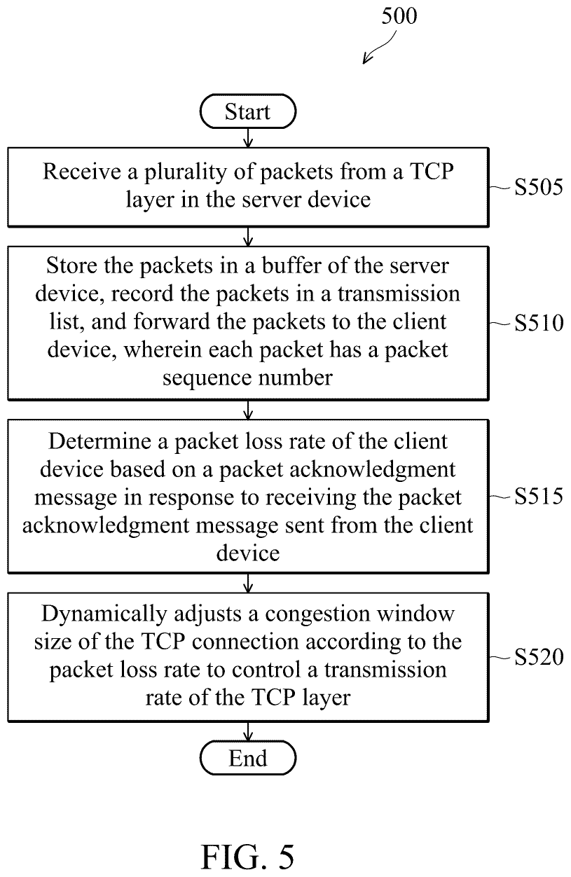

FIG. 5 is a schematic diagram illustrating a method 500 for controlling transmission control protocol performance in a wireless network according to an embodiment of the present disclosure. The method 500 is executed by the server device 120 as shown in FIG. 1, and the server device is in communication with a client device based on a TCP connection.

In step S505, a management module in the server device receives a plurality of packets from a TCP layer in the server device.

In step S510, the management module stores the packets in a buffer of the server device, records the packets in a transmission list, and forwards the packets to the client device, wherein each packet has a packet sequence number.

In step S515, the management module determines a packet loss rate of the client device based on a packet acknowledgment message in response to receiving the packet acknowledgment message sent from the client device, wherein the packet confirmation message comprises a latest confirmation sequence number and lost packet sequence numbers. In one embodiment, the packet acknowledgment message may comprise a selective acknowledgment (SACK) message or an acknowledgment (ACK) message.

In step S520, the management module dynamically adjusts a congestion window size of the TCP connection according to the packet loss rate to control a transmission rate of the TCP layer. Specifically, the management module may obtain an optimal congestion window threshold based on the packet loss rate. When the congestion window size is greater than the optimal congestion window threshold, the management module sends a first false acknowledgment message to the TCP layer to instruct the TCP layer to reduce the congestion window size, wherein the first false acknowledgment message is a duplicate ACK (DUP ACK) message. When the congestion window size is smaller than the optimal congestion window threshold, the management module sends a second false acknowledgment message to the TCP layer to instruct the TCP layer to increase the congestion window size, wherein the second false acknowledgment message is an acknowledgment (ACK) message.

In one embodiment, the management module retransmits the lost packets corresponding to the lost packet sequence numbers to the client device according to the packet acknowledgment message, and deletes the packets whose packet sequence numbers are smaller than the latest confirmation sequence number and are not the lost packet sequence numbers.

As mentioned above, the method and the device for controlling transmission control protocol performance in a wireless network and system thereof provided in the present disclosure can intercept the packet acknowledgment messages sent by the client device and send a false acknowledgment message to the TCP layer according to the packet loss rate to control the congestion window size within an ideal range and further achieve the purpose of controlling the transmission rate of the TCP layer.

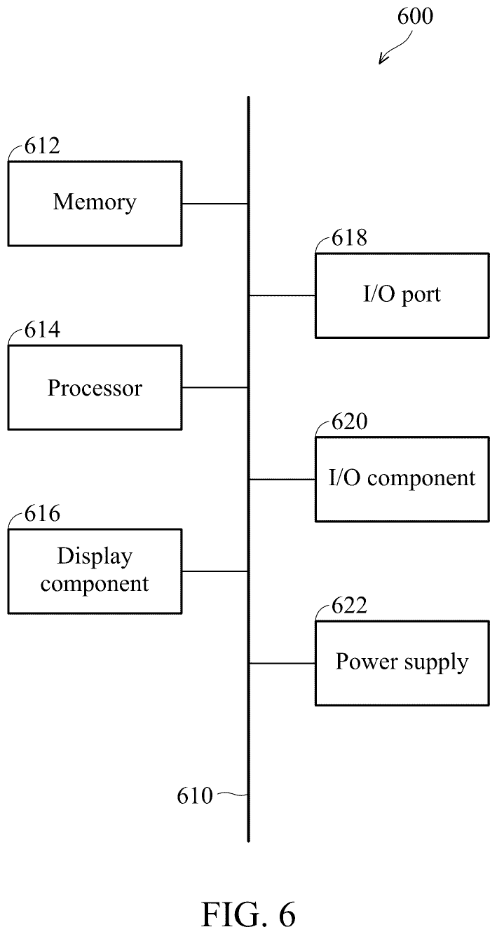

The embodiments described herein, including systems, methods/processes, and/or apparatuses, may be implemented using well known servers/computers, such as an electronic device 600 shown in FIG. 6. For example, the client device 120 and the server device 120 can be implemented using one or more electronic device 600. The electronic device 600 is described as follows, for purposes of illustration.

Referring to FIG. 6, an exemplary operating environment for implementing embodiments of the present disclosure is shown and generally known as an electronic device 600. The electronic device 600 is merely an example of a suitable computing environment and is not intended to limit the scope of use or functionality of the disclosure. Neither should the electronic device 600 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 6, the electronic device 600 may include a bus 610 that is directly or indirectly coupled to the following devices: one or more memories 612, one or more processors 614, one or more display components 616, one or more input/output (I/O) ports 618, one or more input/output components 620, and an illustrative power supply 622. The bus 610 may represent one or more kinds of busses (such as an address bus, data bus, or any combination thereof). Although the various blocks of FIG. 6 are shown with lines for the sake of clarity, and in reality, the boundaries of the various components are not specific. For example, the display component such as a display device may be considered an I/O component and the processor may include a memory.

The electronic device 600 typically includes a variety of computer-readable media. The computer-readable media can be any available media that can be accessed by electronic device 600 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 600. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 612 may include computer-storage media in the form of volatile and/or nonvolatile memory. The memory may be removable, non-removable, or a combination thereof. Exemplary hardware devices include solid-state memory, hard drives, optical-disc drives, etc. The electronic device 600 includes one or more processors that read data from various entities such as the memory 612 or the I/O components 620. The display component(s) 616 present data indications to a user or to another device. Exemplary presentation components include a display device, speaker, printing component, vibrating component, etc.

The I/O ports 618 allow the electronic device 600 to be logically coupled to other devices including the I/O components 620, some of which may be embedded. Illustrative components include a microphone, joystick, game pad, satellite dish, scanner, printer, wireless device, etc. The I/O components 620 may provide a natural user interface (NUI) that processes gestures, voice, or other physiological inputs generated by a user. For example, inputs may be transmitted to an appropriate network element for further processing. A NUI may be implemented to realize speech recognition, touch and stylus recognition, facial recognition, biometric recognition, gesture recognition both on screen and adjacent to the screen, air gestures, head and eye tracking, touch recognition associated with displays on the electronic device 600, or any combination thereof. The electronic device 600 may be equipped with depth cameras, such as stereoscopic camera systems, infrared camera systems, RGB camera systems, or any combination thereof, to realize gesture detection and recognition. Furthermore, the electronic device 600 may be equipped with accelerometers or gyroscopes that enable detection of motion. The output of the accelerometers or gyroscopes may be provided to the display of the electronic device 600 to carry out immersive augmented reality or virtual reality.

Furthermore, the processor 614 in the electronic device 600 can execute the program code in the memory 612 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for controlling transmission control protocol performance in a wireless network, wherein the method is used in a server device and the server device is in communication with a client device based on a TCP connection, comprising:
receiving a plurality of packets from a TCP layer in the server device;
storing the packets in a buffer, recording the packets in a transmission list, and forwarding the packets to the client device, wherein each packet has a packet sequence number;
in response to receiving a packet acknowledgment message sent from the client device, determining a packet loss rate of the client device based on the packet acknowledgment message; and
dynamically adjusting a congestion window size of the TCP connection based on the packet loss rate to control a transmission rate of the TCP layer.

2. The method for controlling transmission control protocol performance in a wireless network as claimed in claim 1, wherein the packet acknowledgment message comprises a latest confirmation sequence number and lost packet sequence numbers and the method further comprises:
retransmitting lost packets corresponding to the lost packet sequence numbers to the client device according to the packet acknowledgment message; and
deleting packets whose packet sequence numbers are smaller than the latest confirmation sequence number and are not the lost packet sequence numbers.

3. The method for controlling transmission control protocol performance in a wireless network as claimed in claim 1, wherein the step of dynamically adjusting the congestion window size of the TCP connection based on the packet loss rate to control the transmission rate of the TCP layer further comprises:
obtaining an optimal congestion window threshold based on the packet loss rate;
sending a first false acknowledgment message to the TCP layer to instruct the TCP layer to reduce the congestion window size when the congestion window size is greater than the optimal congestion window threshold; and
sending a second false confirmation message to the TCP layer to instruct the TCP layer to increase the congestion window size when the congestion window size is smaller than the optimal congestion window threshold.

4. The method for controlling transmission control protocol performance in a wireless network as claimed in claim 3, wherein the first false acknowledgment message is a duplicate acknowledgment (DUP ACK) message.

5. The method for controlling transmission control protocol performance in a wireless network as claimed in claim 3, wherein the second false acknowledgment message is an acknowledgment (ACK) message.

6. The method for controlling transmission control protocol performance in a wireless network as claimed in claim 1, further comprising:
receiving a first packet from the TCP layer;
checking whether a first packet sequence number of the first packet is in the transmission list;
when the first packet sequence number is not in the transmission list, storing the first packet in the buffer, recording the first packet in the transmission list, and forwarding the first packet to the client device; and
discarding the first packet when the first packet sequence number is in the transmission list.

7. The method for controlling transmission control protocol performance in a wireless network as claimed in claim 1, wherein the packet acknowledgment message comprises a selective acknowledgment (SACK) message.

8. The method for controlling transmission control protocol performance in a wireless network as claimed in claim 1, wherein the packet acknowledgment message comprises an acknowledgment (ACK) message.

9. A device for controlling transmission control protocol performance in a wireless network, wherein the device is in communication with a client device based on a TCP connection, comprising:
one or more processors; and
one or more computer storage media for storing one or more computer-readable instructions, wherein the processor is configured to drive the computer storage media to execute the following tasks:
receiving a plurality of packets from a TCP layer in the device;
storing the packets in a buffer, recording the packets in a transmission list, and forwarding the packets to the client device, wherein each packet has a packet sequence number;
in response to receiving a packet acknowledgment message sent from the client device, determining a packet loss rate of the client device based on the packet acknowledgment message; and
dynamically adjusting a congestion window size of the TCP connection based on the packet loss rate to control a transmission rate of the TCP layer.

10. The device for controlling transmission control protocol performance in a wireless network as claimed in claim 9, wherein the packet acknowledgment message comprises a latest confirmation sequence number and lost packet sequence numbers and the processor further executes the following tasks:
retransmitting lost packets corresponding to the lost packet sequence numbers to the client device according to the packet acknowledgment message; and
deleting packets whose packet sequence numbers are smaller than the latest confirmation sequence number and are not the lost packet sequence numbers.

11. The device for controlling transmission control protocol performance in a wireless network as claimed in claim 9, wherein the step of dynamically adjusting the congestion window size of the TCP connection based on the packet loss rate to control the transmission rate of the TCP layer further comprises:
obtaining an optimal congestion window threshold based on the packet loss rate;
sending a first false acknowledgment message to the TCP layer to instruct the TCP layer to reduce the congestion window size when the congestion window size is greater than the optimal congestion window threshold; and
sending a second false confirmation message to the TCP layer to instruct the TCP layer to increase the congestion window size when the congestion window size is smaller than the optimal congestion window threshold.

12. The device for controlling transmission control protocol performance in a wireless network as claimed in claim 11, wherein the first false acknowledgment message is a duplicate acknowledgment (DUP ACK) message.

13. The device for controlling transmission control protocol performance in a wireless network as claimed in claim 11, wherein the second false acknowledgment message is an acknowledgment (ACK) message.

14. The device for controlling transmission control protocol performance in a wireless network as claimed in claim 9, wherein the processor further executes the following tasks:
receiving a first packet from the TCP layer;
checking whether a first packet sequence number of the first packet is in the transmission list;
when the first packet sequence number is not in the transmission list, storing the first packet in the buffer, recording the first packet in the transmission list, and forwarding the first packet to the client device; and
discarding the first packet when the first packet sequence number is in the transmission list.

15. The device for controlling transmission control protocol performance in a wireless network as claimed in claim 9, wherein the packet acknowledgment message comprises a selective acknowledgment (SACK) message.

16. The device for controlling transmission control protocol performance in a wireless network as claimed in claim 9, wherein the packet acknowledgment message comprises an acknowledgment (ACK) message.

17. A system for controlling transmission control protocol performance in a wireless network, comprising:
a client device; and
a server device, wherein the server device is in communication with based on a transmission control protocol (TCP) connection and executes the following tasks:
receiving a plurality of packets from a TCP layer in the server device;
storing the packets in a buffer, recording the packets in a transmission list, and forwarding the packets to the client device, wherein each packet has a packet sequence number;
in response to receiving a packet acknowledgment message sent from the client device, determining a packet loss rate of the client device based on the packet acknowledgment message; and
dynamically adjusting a congestion window size of the TCP connection based on the packet loss rate to control a transmission rate of the TCP layer.

18. The system for controlling transmission control protocol performance in a wireless network as claimed in claim 17, wherein the packet acknowledgment message comprises a latest confirmation sequence number and lost packet sequence numbers and the server device further executes the following tasks:
retransmitting lost packets corresponding to the lost packet sequence numbers to the client device according to the packet acknowledgment message; and
deleting packets whose packet sequence numbers are smaller than the latest confirmation sequence number and are not the lost packet sequence numbers.

19. The system for controlling transmission control protocol performance in a wireless network as claimed in claim 17, wherein the step of dynamically adjusting the congestion window size of the TCP connection based on the packet loss rate to control the transmission rate of the TCP layer further comprises:
obtaining an optimal congestion window threshold based on the packet loss rate;
sending a first false acknowledgment message to the TCP layer to instruct the TCP layer to reduce the congestion window size when the congestion window size is greater than the optimal congestion window threshold; and
sending a second false confirmation message to the TCP layer to instruct the TCP layer to increase the congestion window size when the congestion window size is smaller than the optimal congestion window threshold.

20. The system for controlling transmission control protocol performance in a wireless network as claimed in claim 19, wherein the first false acknowledgment message is a duplicate acknowledgment (DUP ACK) message.

21. The system for controlling transmission control protocol performance in a wireless network as claimed in claim 19, wherein the second false acknowledgment message is an acknowledgment (ACK) message.

22. The system for controlling transmission control protocol performance in a wireless network as claimed in claim 17, wherein the server device further executes the following tasks:
receiving a first packet from the TCP layer;
checking whether a first packet sequence number of the first packet is in the transmission list;
when the first packet sequence number is not in the transmission list, storing the first packet in the buffer, recording the first packet in the transmission list, and forwarding the first packet to the client device; and
discarding the first packet when the first packet sequence number is in the transmission list.

23. The system for controlling transmission control protocol performance in a wireless network as claimed in claim 17, wherein the packet acknowledgment message comprises a selective acknowledgment (SACK) message.

24. The system for controlling transmission control protocol performance in a wireless network as claimed in claim 17, wherein the packet acknowledgment message comprises an acknowledgment (ACK) message.
